(19) United States
(12) Patent Application Publication
(10) Pub. No.: US 2007/0288907 A1
(43) Pub. Date: Dec. 13, 2007

(54) Method and apparatus for debugging applications executed on a software relaxed consistency architecture

(76) Inventors: Jeffrey V. Olivier, Champaign, IL (US); Chih-Ping Chen, Nashua, NH (US); Jay P. Hoeflinger, Urbana, IL (US); Bevin R. Brett, Brookline, NH (US)

Correspondence Address: Lawrence Cho Attorney at Law;C/O INTELLEVATE, P.O. Box 52050, Minneapolis, MN, 55402, US

(21) Appl. No.: 11/434,738

(22) Filed: May 16, 2006

(51) Int. Cl. G06F 9/44

(52) U.S. Cl. 717/129

(57) ABSTRACT

A method for debugging a program includes identifying a thread in an unsafe state during a breakpoint. The thread is allowed to continue execution until it reaches a safe state while preventing other threads from executing. According to one aspect of the invention, the thread is in the unsafe state when the thread is executing code to access sharable memory and the sharable memory is in transition. Other embodiments are described and claimed.

### FIELD

An embodiment of the present invention relates to debuggers. More specifically, an embodiment of the present invention relates to a method and apparatus for debugging applications executed on a shared memory system using a software relaxed consistency architecture.

### BACKGROUND

A consistency model is a formal specification of memory semantics of a shared memory system. There are two consistency models that are commonly used for a shared memory system, the sequential consistency model and the relaxed consistency model. The sequential consistency model manages the operations of a multiprocessor system such that the operations are interleaved in some overall sequential order. The operations of each individual processor appear in the sequential order as specified by its program.

A relaxed consistency model relaxes the constraints imposed by sequential consistency. Certain memory operations are allowed to be overlapped in order to improve the execution speed of the program. The relaxed consistency model allows certain memory locations to be in an invalid state at points during execution of a program as long as the memory locations are brought up to date at the time the program needs to reference them.

Standard debuggers have difficulties reading from and writing to a shared memory system utilizing a relaxed consistency model implemented in software. A read directly to a sharable memory location in the shared memory system may access data that is out of date. A direct write to a sharable memory location in the shared memory system may not result in the written value being updated in sharable memory on other processes. Furthermore, single stepping a thread, where a user analyzes the execution of code one instruction at a time, may hang on an access to sharable memory if some local or remote thread is unable to run, yet holds a lock preventing the memory from being brought up-to-date.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram of a set of nodes connected by a network interconnect according to an example embodiment of the present invention.

FIG. 2 is a block diagram of a computer system according to an example embodiment of the present invention.

FIG. 3 is a software relaxed consistency library (SRCL) according to an example embodiment of the present invention.

FIG. 4A is a flow chart of a method for managing reads from a sharable memory according to an example embodiment of the present invention.

FIG. 4B is a flow chart of a method for managing writes to a sharable memory according to an example embodiment of the present invention.

FIG. 5 is a block diagram of a debugger unit according to an example embodiment of the present invention.

FIG. 6 is a flow chart of a method for facilitating a safe state transition according to an example embodiment of the present invention.

FIG. 7A is a flow chart of a method for writing to a sharable memory during a debugging session according to an example embodiment of the present invention.

FIG. 7B is a flow chart of a method for reading from a sharable memory during a debugging session according to an example embodiment of the present invention.

### DETAILED DESCRIPTION

In the following description, for purposes of explanation, specific nomenclature is set forth to provide a thorough understanding of embodiments of the present invention. However, it will be apparent to one skilled in the art that specific details in the description may not be required to practice the embodiments of the present invention. In other instances, well-known components, programs, and procedures are shown in block diagram form to avoid obscuring embodiments of the present invention unnecessarily.

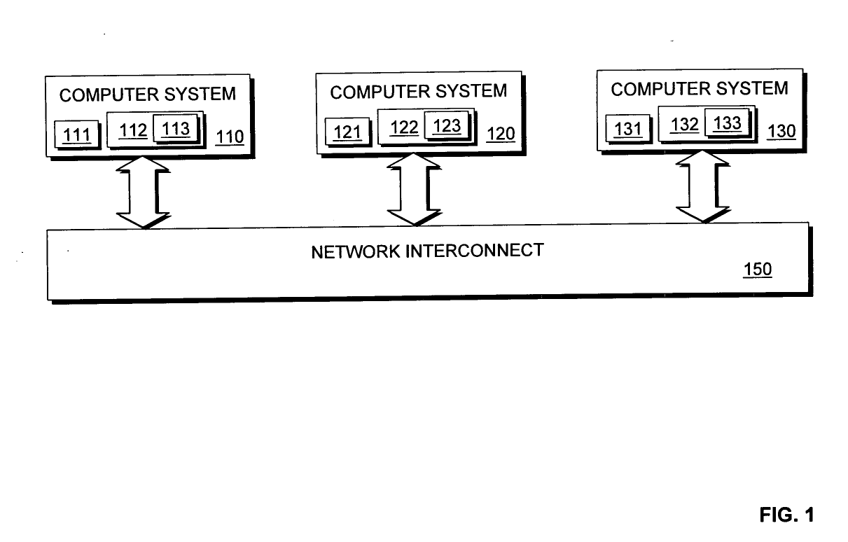

FIG. 1 is a block diagram of a set of nodes connected by a network interconnect according to an example embodiment of the present invention. Block 110 represents a first node. Block 120 represents a second node. Block 130 represents an n-th node, where n can be any number. The nodes are coupled to a network interconnect 150. The network interconnect 150 may be implemented using any transmission medium and utilizing any appropriate transmission protocol. Each of the nodes may be implemented by a computer system having one or more processors and memory. Blocks 111, 121, and 131 represent one or more processors on nodes 110, 120, and 130. Blocks 112, 122, and 132 represent the memory on nodes 110, 120, and 130.

The nodes 110, 120, 130 may utilize a relaxed consistency model where the consistency of memory 112, 122, and 132 is managed by a software relaxed consistency library (SRCL) 113, 123, and 133. The SRCLs 113, 123, and 133 allow the nodes 110, 120, and 130 to run an application that depends on a shared memory paradigm. A process can be created on each node. Accesses to sections in each memory 112, 122, and 132 marked as shared (sharable memory) between nodes are monitored by the SRCL for reads and writes in order to maintain consistent values before a memory is accessed.

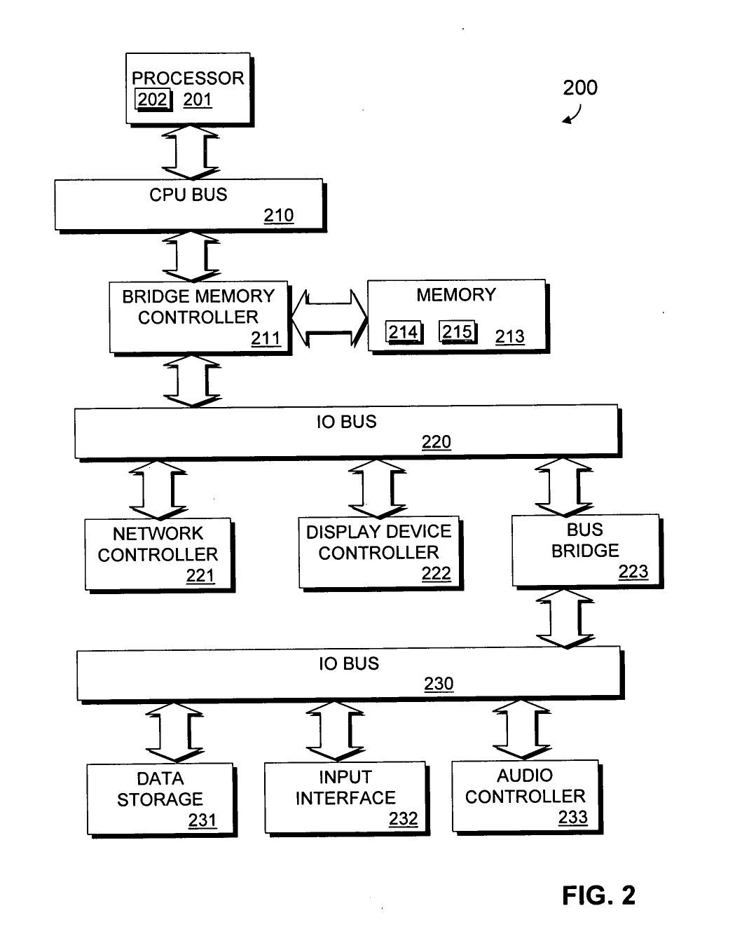

FIG. 2 is a block diagram of an exemplary computer system 200 according to an embodiment of the present invention. The computer system 200 may be used to implement one of the nodes illustrated in FIG. 1. The computer system 200 includes a processor 201 that processes data signals and a memory 213. The processor 201 may include one or more processor cores. The processor 201 may be a complex instruction set computer microprocessor, a reduced instruction set computing microprocessor, a very long instruction word microprocessor, a processor implementing a combination of instruction sets, or other processor device. FIG. 2 shows the computer system 200 with a single processor. However, it is understood that the computer system 200 may operate with multiple processors. Additionally, each of the one or more processors may support one or more threads. The processor 201 is coupled to a CPU bus 210 that transmits data signals between processor 201 and other components in the computer system 200.

The memory 213 may be a dynamic random access memory device, a static random access memory device, read-only memory, and/or other memory device. The memory 213 may store instructions and code represented by data signals that may be executed by the processor 201. According to an example embodiment of the computer system 200, an SRCL 214 and a debugger unit 215 may be stored in the memory 213 and implemented by the processor 201 in the computer system 200. The SRCL 214 may manage a section in memory 213 designated as sharable memory. The debugger unit 215 may be used to debug programs executed by the processor 201. The debugger unit 215 may debug applications that utilize a shared memory paradigm and read values from and write values to the sharable memory during a debug session.

A cache memory 202 resides inside processor 201 that stores data signals stored in memory 213. The cache 202 speeds access to memory by the processor 201 by taking advantage of its locality of access. In an alternate embodiment of the computer system 200, the cache 202 resides external to the processor 201. A bridge memory controller 211 is coupled to the CPU bus 210 and the memory 213. The bridge memory controller 211 directs data signals between the processor 201, the memory 213, and other components in the computer system 200 and bridges the data signals between the CPU bus 210, the memory 213, and a first IO bus 220.

The first IO bus 220 may be a single bus or a combination of multiple buses. The first IO bus 220 provides communication links between components in the computer system 200. A network controller 221 is coupled to the first IO bus 220. The network controller 221 may link the computer system 200 to a network of computers (not shown) and supports communication among the machines. A display device controller 222 is coupled to the first IO bus 220. The display device controller 222 allows coupling of a display device (not shown) to the computer system 200 and acts as an interface between the display device and the computer system 200.

A second IO bus 230 may be a single bus or a combination of multiple buses. The second IO bus 230 provides communication links between components in the computer system 200. A data storage device 231 is coupled to the second IO bus 230. The data storage device 231 may be a hard disk drive, a floppy disk drive, a CD-ROM device, a flash memory device or other mass storage device. An input interface 232 is coupled to the second IO bus 230. The input interface 232 may be, for example, a keyboard and/or mouse controller or other input interface. The input interface 232 may be a dedicated device or can reside in another device such as a bus controller or other controller. The input interface 232 allows coupling of an input device to the computer system 200 and transmits data signals from an input device to the computer system 200. An audio controller 233 is coupled to the second IO bus 230. The audio controller 233 operates to coordinate the recording and playing of sounds and is also coupled to the IO bus 230. A bus bridge 223 couples the first IO bus 220 to the second IO bus 230. The bus bridge 223 operates to buffer and bridge data signals between the first IO bus 220 and the second IO bus 230.

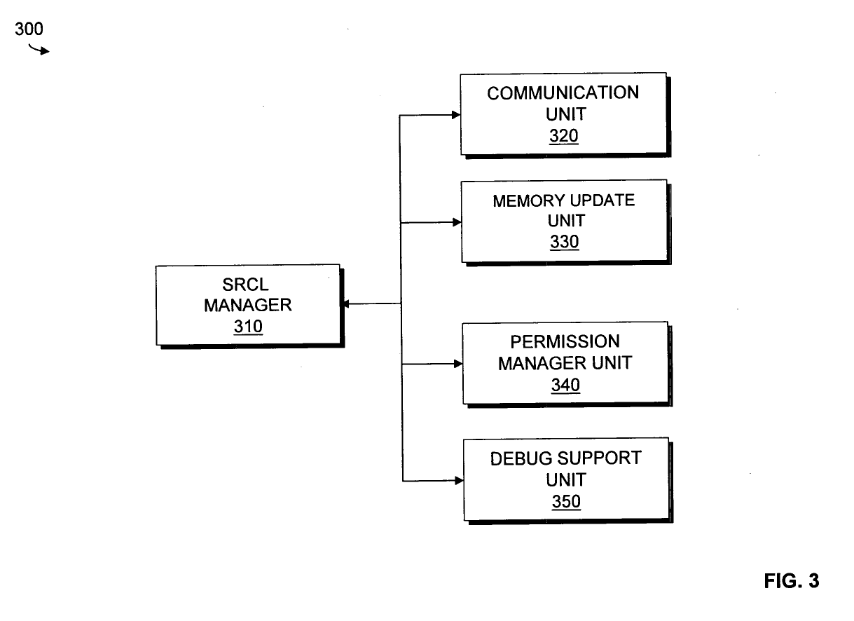

FIG. 3 is a software relaxed consistency library (SRCL) 300 according to an example embodiment of the present invention. The SRCL 300 may be used to implement the SRCL 214 shown in FIG. 2. The SRCL 300 includes a SRCL manager 310. The SRCL manager 310 interfaces with and transmits information between other components in the SRCL 300.

The SRCL 300 includes a communication unit 320. The communication unit 320 communicates with SRCLs associated with other nodes in a network that are running an application that depends on a shared memory paradigm. The communication unit 320 may use a messaging scheme to send a notification to other SRCLs when its associated (local) sharable memory has been written to and when one or more values in its associated sharable memory has been updated. The communication unit 320 may also receive notifications from other SRCLs that indicate that other sharable memories have been written to and the identity of one or more locations that have been updated and its values. It should be appreciated that the notifications may be sent and received upon specific request or may be sent and received automatically upon the occurrence of an update to a sharable memory. The communication unit 320 may also send and receive information regarding a state of a sharable memory in the network.

The SRCL 300 includes a memory update unit 330. The memory update unit 330 updates its associated sharable memory with information received from remote SRCLs upon determining that a read or write access is desired on its local sharable memory and determining that the local sharable memory is invalid.

The SRCL 300 includes a permission manager unit 340. The permission manager unit 340 manages the state of variables in a sharable memory. According to an embodiment of the SRCL 300, upon updating a sharable memory after a read access, the permission manager unit 340 sets a state of variables in the sharable memory to READ ONLY. Upon creating a copy of sharable memory after a write access, the permission manager unit 340 sets a state of the sharable variables in the sharable memory to READ/WRITE. Upon receiving notification that a remote sharable memory has been updated, the permission manager unit 340 sets a state of sharable variables in the sharable memory to NO ACCESS, which indicates that the sharable variable in the sharable memory is invalid because it does not have the most current up to date value. The SRCL manager 310 prompts the memory update unit 330 to update its associated sharable memory with values received by the communication unit 320 upon determining that a sharable memory is in a NO ACCESS state during a read or write access.

According to an embodiment of the present invention, accesses to memory that are marked as shared between nodes and clusters (sharable memory) are monitored by the communication unit 320 of the SRCL 300 for read and writes. This may be done by cycling page protections between NO ACCESS, READ ONLY, and READ/WRITE, depending on data access patterns of a program. When a page is not fully up-to-date, it is protected with NO ACCESS. Any access causes a segmentation fault that is delivered to the SRCL. To bring the page up-to-date, messages are sent to remote nodes, requesting any changes made to the page by the nodes.

The SRCL 300 includes a debug support unit 350. The debug support unit 350 provides support to a debugger unit when a read or write access to a sharable memory is desired by a user of the debugger. The debug support unit 350 allows a debugger unit to read valid variables from a sharable memory and write variables to other sharable memory in a network during a debugging session as will be described.

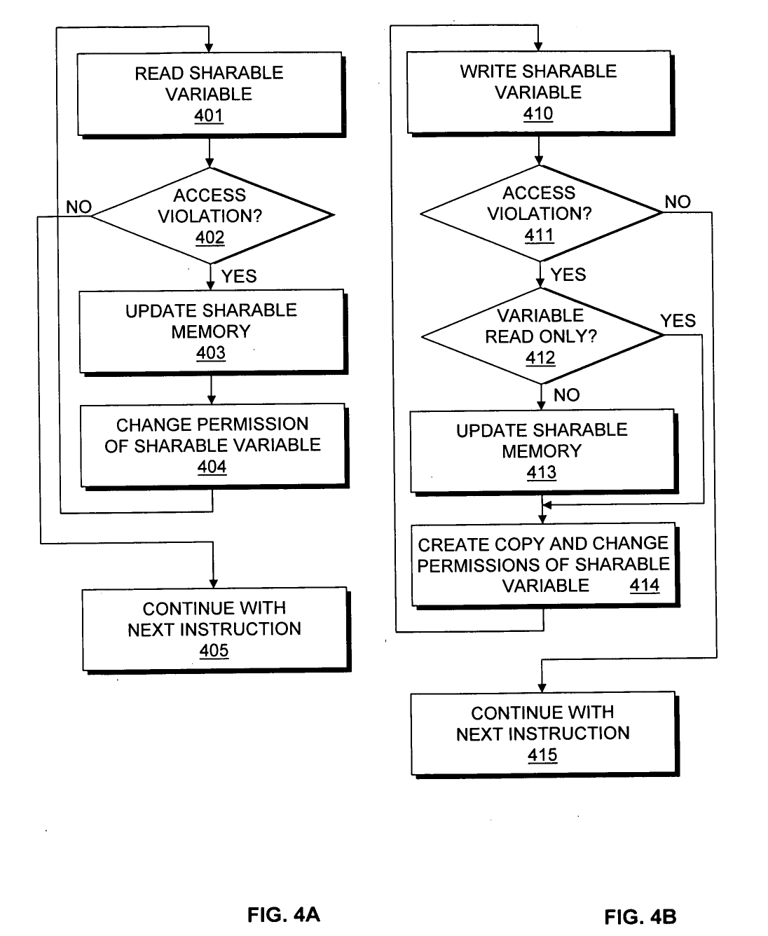

FIGS. 4A and 4B are flow charts of a method for managing reads and a method for managing writes to a sharable memory according to example embodiments of the present invention. According to an embodiment of the present invention, the procedures shown in FIGS. 4A and 4B may be performed by the SRCL shown in FIG. 3. With reference to FIG. 4A, at 401 a sharable variable is read from a sharable memory. The sharable variable may be any value stored in the sharable memory.

At 402, a determination is made as to whether an access violation occurred. According to an embodiment of the present invention, an access violation occurs when a read is made to a sharable variable that is in a NO ACCESS state. If it is determined that an access violation occurred, control proceeds to 403. If it is determined that an access violation has not occurred, control proceeds to 405.

At 403, the sharable memory is updated. According to an embodiment of the present invention, a request for updated values is made from relevant remote processes and the updated values received are written into the local sharable memory.

At 404, the permission of the sharable variable is changed to READ ONLY. According to an embodiment of the present invention, if the entire sharable memory has been updated, the sharable variables in the entire sharable memory may be changed to READ ONLY. Alternatively, if only a section or page of the sharable memory has been updated, only the sharable variables in the section or page of sharable memory may be changed to READ ONLY.

At 405, control proceeds with a next instruction.

With reference to FIG. 4B, at 410 a sharable variable is written to a sharable memory. The sharable variable may be any value stored in the sharable memory.

At 411, a determination is made as to whether an access violation occurred. According to an embodiment of the present invention, an access violation occurs when a write is made to a sharable variable that is in a NO ACCESS state or a READ ONLY state. If it is determined that an access violation occurred, control proceeds to 412. If it is determined that an access violation has not occurred, control proceeds to 415.

At 412, it is determined whether the sharable variable is in a READ ONLY state. If the shared variable is in a READ ONLY state, control proceeds to 414. If the shared variable is not in a READ ONLY state, control proceeds to 413.

At 413, the sharable memory is updated. According to an embodiment of the present invention, a request for updated values is made and the updated values received are written into the local sharable memory.

At 414, a copy of the shared memory is made and the permission of the sharable variable is changed to READ/WRITE. According to an embodiment of the present invention, if the entire sharable memory has been updated, the sharable variables in the entire sharable memory may be changed to READ/WRITE. Alternatively, if only a section or page of the sharable memory has been updated, only the sharable variables in the section or page of sharable memory may be changed to READ/WRITE.

At 415, control proceeds with a next instruction.

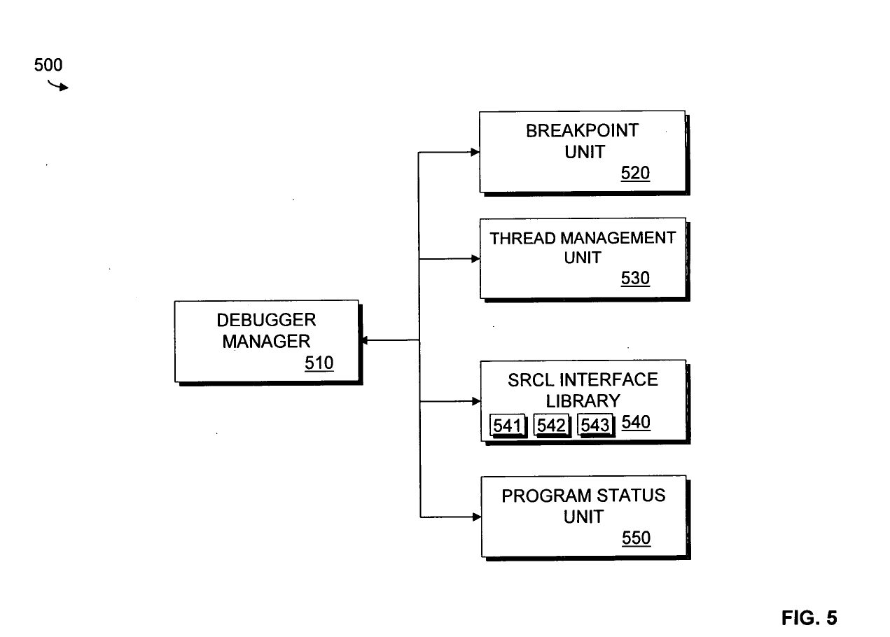

FIG. 5 is a block diagram of a debugger unit 500 according to an example embodiment of the present invention. The debugger unit 500 may be used to implement the debugger unit 215 shown in FIG. 2. The debugger unit 500 includes a debugger manager 510. The debugger manager 510 is coupled to and transmits information between components in the debugger unit 500.

The debugger unit 500 includes a breakpoint unit 520. The breakpoint unit 520 allows a user to set up breakpoints in a program to be debugged. The breakpoints may include mechanisms to pause the program when an identified line in the program code is reached or a condition associated with the program becomes true. In a multi-threaded program, a focus thread is a thread that triggers a breakpoint. A focus process is a process that started the focus thread.

The debugger unit 500 includes a thread management unit 530. The thread management unit 530 controls the execution of threads. The thread management unit 530 may attach to and stop a process or a SRCL application when a breakpoint is triggered. The thread management unit 530 may start and stop a subset of threads in a process. When a thread is stopped, the thread management unit 530 may also execute a procedure defined in the program being debugged on that thread to achieve certain debugging goals. Such execution is referred to as an inferior call.

The debugger unit 500 includes an SRCL interface library 540. The SRCL interface library 540 includes a thread status unit 541. The thread status unit 541 identifies threads that are in an unsafe state during a breakpoint. The thread status unit 541 directs the thread management unit 530 to continue execution of threads that are in an unsafe state until the threads are brought to a safe state. According to an embodiment of the SRCL interface library 540, a user thread is determined to be in a safe state by the thread status unit 541 when the following two conditions are true. User threads are threads in the process that execute user code in the application. First, the user thread is executing outside of blocks 403 and 404 in FIG. 4A, and blocks 412-414 in FIG. 4B. If the user thread is executing procedures within these blocks, the state of the sharable memory is in transition. Such a state transition should be atomic from the perspective of the debugger unit 500 since the state of sharable memory is unknown during the transition. Second the user thread is not executing code in a SRCL that would prevent another thread in the same process from performing the procedures of blocks 403 and 404 in FIG. 4A, and blocks 412-414 in FIG. 4B. Failure to ensure this condition could result in deadlock if a single-stepping thread manipulates sharable memory. According to an embodiment of the debugger unit 500, a helper thread is determined to be in a safe state by the thread status unit 541 when the following two conditions are true. Helper threads are threads that service messages sent between nodes in order to manage the sharable memory in a node. First, the helper thread is part of a focus process. Second the user thread is not executing code in a SRCL that would prevent another thread in the same process from performing the procedures of blocks 403 and 404 in FIG. 4A, and blocks 412-414 in FIG. 4B.

The SRCL interface library 540 includes a debug write unit 542. The debug write unit 542 facilitates writing to a sharable memory during the debugging of a program. According to an embodiment of the SRCL interface library 540, the debug write unit 542 makes an inferior call to allocate a buffer, writes a sharable variable to the buffer, and calls an inferior call to copy the sharable variable from the buffer to the sharable memory using the SRCL. By using the SRCL instead of writing directly into the sharable memory, the update to the sharable variable may be transmitted to other remote processes or SRCLs to keep the sharable memories in a system consistent, as in FIG. 4B.

The SRCL interface library 540 includes a debug read unit 543. The debug read unit 543 facilitates reading a sharable memory during the debugging of a program. According to an embodiment of the SRCL interface library 540, the debug read unit 543 makes an inferior call to allocate a buffer and to copy the sharable variable from the sharable memory to the buffer using the SRCL, and reading the sharable memory from the buffer. By using the SRCL instead of reading directly from the sharable memory, a valid value for the sharable variable may be read.

The debugger unit 500 includes a program status unit 550. The program status unit 550 may check a program's internal state such as register values, memory values, and call stack to help a user to find the cause of a bug.

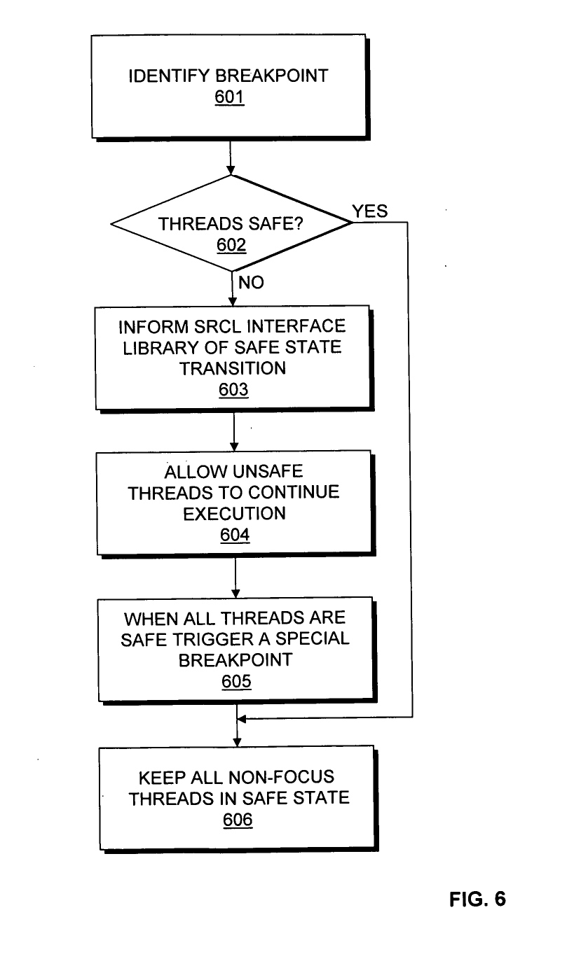

FIG. 6 is a flow chart of a method for facilitating a safe state transition according to an example embodiment of the present invention. The procedures illustrated in FIG. 6 may be implemented in part by the debugger unit 500 shown in FIG. 5. At 601, a breakpoint is identified.

At 602, it is determined whether the threads are in a safe state. Threads which the SRCL is aware of, including user threads executing the application and helper threads, are considered. Threads which are not considered are assumed to be in a safe state and are held from further execution. According to an embodiment of the present invention, a query to an SRCL interface library may be made to determine the identity of any thread that is in an unsafe state. It should be appreciated that the conditions discussed with reference to the thread status unit 520 may be used to determine whether a thread is in a safe state. If it is determined that the threads are safe, control proceeds to 606. If it is determined that the threads are not in a safe state, control proceeds to 603.

At 603, the SRCL interface library is informed of a safe state transition. According to an embodiment of the present invention, a flag is set in the SRCL process.

At 604, threads that are not in a safe state are allowed to continue execution. The threads that are allowed to continue execution may include user threads that are in an unsafe state and helper threads that may have been stopped. Other threads remain stopped. A barrier may be set to limit execution of threads.

At 605, a breakpoint is triggered when all the threads are in a safe state.

At 606, all non-focus threads are kept in a safe state until the application is continued.

According to an embodiment of the present invention, the procedure described with reference to FIG. 6 may be applied to application level transitions as well as process level transitions to facilitate safe state transitions.

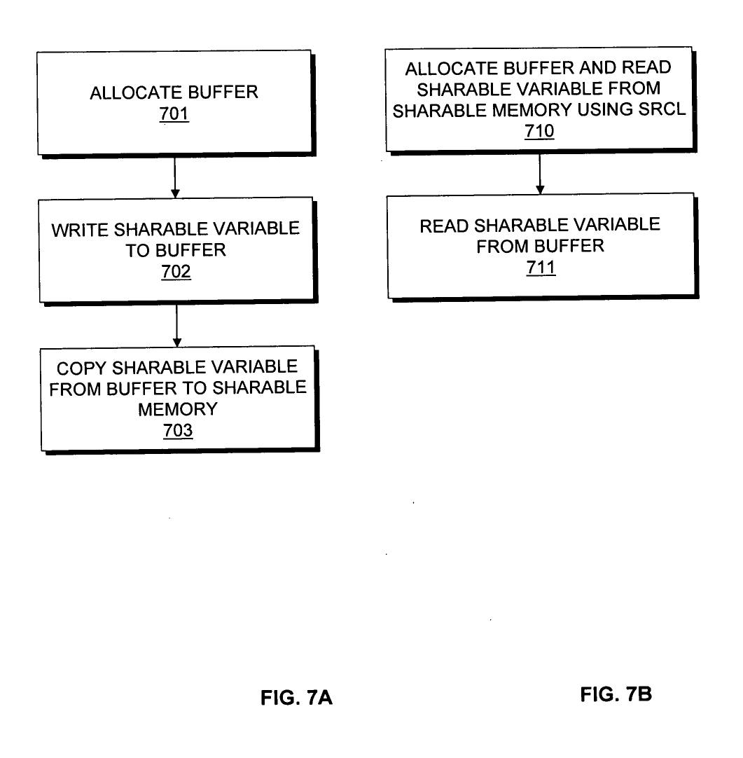

FIG. 7A is a flow chart of a method for writing to a sharable memory during a debugging session according to an example embodiment of the present invention. The procedure shown in FIG. 7A may be implemented by the debug write unit 542. At 701, a buffer is allocated. According to an embodiment of the present invention, an inferior call is made to allocate the buffer. In one embodiment, the buffer may be allocated by using the exemplary pseudo code below.

```
void SRCL_allocated(size)
{
  if(!SRCL_buffer)//first time
  {
    SRCL_buffer = malloc(size);
    SRCL_buffer_size=size;
  }
  if (SRCL_buffer_size<size)
  {//enlarge if necessary
    SRCL_buffer = realloc(SRCL_buffer, size);
    SRCL_buffer_size = size;
  }
}
```

At 702, a new value for the sharable variable is written to the buffer. According to an embodiment of the present invention, the write may be implemented using a debugger callback.

At 703, the new value is copied into the sharable memory using the SRCL. By using the SRCL instead of writing directly into the sharable memory, the update to the sharable variable may be transmitted to other remote processes or SRCLs to keep the sharable memories in a system consistent. According to an embodiment of the present invention, an inferior call is made to copy the new value to the sharable variable. In one embodiment, the sharable variable may be copied into the sharable memory by using the exemplary pseudo code below.

void SRCL_write_var(dest, size)
{
memcpy (dest, SRCL_buffer, size);
}

FIG. 7B is a flow chart of a method for reading from a sharable memory during a debugging session according to an example embodiment of the present invention. The procedure shown in FIG. 7B may be implemented by the debug read unit 543.

At 710, a buffer is allocated and a sharable variable is read from the sharable memory using the SRCL. According to an embodiment of the present invention, the allocation of the buffer and reading may be performed by making an inferior call. In one embodiment, the allocation and reading may be performed using the exemplary pseudo code below.

```
void SRCL_read_var(src, size)
{
  SRCL_allocated(size);
  memcpy (SRCL_buffer, src, size);
}
```

At 711, the value of the sharable variable is read from the buffer. According to an embodiment of the present invention, a debugger callback is used to read the value of the sharable variable from the buffer.

It should be appreciated that the procedures referred to in FIGS. 7A and 7B may be SRCL runtime routines. The SRCL runtime routines may be implemented from a debug support unit such the debug support unit 350 shown in FIG. 3.

Embodiments of the present invention allow reads to a sharable memory to obtain valid values and writes to sharable memory to be correctly propagated to all processes in an application during a debugging session. An inherent mechanism of the SRCL is employed to bring the sharable memory into a safe state that is usable, while preventing the safe threads from executing user code. User threads are brought into a safe state and are prevented from executing any further user code, while helper threads are brought into a safe state and are allowed to perform their normal functions for maintaining memory consistency. This allows a debugger unit to inform the application that it is reading or writing memory and to start the application to run an SRCL protocol. Once the sharable memory is brought up-to-date, a special breakpoint is signaled and the debugger unit is allowed to complete its access to sharable memory validly. Similarly, if a focus thread single steps an instruction that accesses invalid sharable memory, the SRCL protocol will bring the memory up-to-date so that the instruction can be completed.

FIGS. 4A, 4B, 6, 7A, and 7B are flow charts illustrating example embodiments of the present invention. The techniques illustrated in the flow charts may be performed sequentially, in parallel or in an order other than that which is described. It should be appreciated that not all of the techniques described are required to be performed, that additional techniques may be added, and that some of the illustrated techniques may be substituted with other techniques.

Embodiments of the present invention may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

In the foregoing specification embodiments of the invention have been described with reference to specific exemplary embodiments thereof. It will, however, be evident that various modifications and changes may be made thereto without departing from the broader spirit and scope of the embodiments of the invention. The specification and drawings are, accordingly, to be regarded in an illustrative rather than restrictive sense.

What is claimed is:

1. A method for debugging a program, comprising:
identifying a thread in an unsafe state during a breakpoint; and
allowing the thread to continue execution until it reaches a safe state while preventing other threads from executing.

2. The method of claim 1, wherein the thread is in the unsafe state when the thread is executing code to access sharable memory and the sharable memory is in transition.

3. The method of claim 1, wherein the thread is in the unsafe state when the thread is executing code that prevents another thread from executing code to access sharable memory.

4. The method of claim 1, wherein the thread is in the unsafe state when the thread is a helper thread.

5. The method of claim 1, further comprising:
updating a sharable memory if the sharable memory is invalid; and
reading from the sharable memory.

6. The method of claim 5, wherein updating the sharable memory comprises utilizing a software relaxed consistency library (SRCL).

7. The method of claim 5, wherein reading from the sharable memory, comprises:
generating a buffer;
reading a value from the sharable memory to the buffer; and
reading the value from the buffer.

8. The method of claim 5, further comprising:
writing to a sharable memory; and
maintaining consistency of the sharable memory.

9. The method of claim 8, wherein writing to the sharable memory comprises:
generating a buffer;
writing a value to the buffer; and
copying the value in the buffer into the sharable memory.

10. The method of claim 7, wherein maintaining consistency of the sharable memory comprises utilizing a software relaxed consistency library (SRCL).

11. An article of manufacture comprising a machine accessible medium including sequences of instructions, the sequences of instructions including instructions which when executed cause the machine to perform:
identifying a thread in an unsafe state during a breakpoint; and
allowing the thread to continue execution until it reaches a safe state while preventing other threads from executing.

12. The article of manufacture of claim 11, wherein the thread is in the unsafe state when the thread is executing code to access sharable memory and the sharable memory is in transition.

13. The article of manufacture of claim 11, further comprising instructions which when executed causes the machine to further perform
updating a sharable memory if the sharable memory is invalid; and
reading from the sharable memory.

14. The article of manufacture of claim 13, wherein updating the sharable memory comprises utilizing a software relaxed consistency library (SRCL).

15. The article of manufacture of claim 14, wherein reading from the sharable memory, comprises:
generating a buffer;
reading a value from the sharable memory to the buffer; and
reading the value from the buffer.

16. A debugger unit, comprising:
a software relaxed consistency library (SRCL) interface library unit to identify a thread in an unsafe state during a breakpoint; and
a thread management unit to allow the thread to continue execution until it reaches a safe state while preventing other threads from executing.

17. The debugger unit of claim 16, wherein the SRCL interface library unit comprises a debug write unit to write to a sharable memory, and to maintain consistency of the sharable memory.

18. The debugger unit of claim 17, wherein the debug write unit maintains consistency of the sharable memory by making an inferior call to a SRCL runtime routine.

19. The debugger unit of claim 16, wherein the SRCL interface library unit comprises a debug read unit to update a sharable memory if the sharable memory is invalid, and to read from the sharable memory.

20. The debugger unit of claim 19, wherein the debug read unit updates the sharable memory by making an inferior call to a SRCL runtime routine.
